(19) United States
(12) Patent Application Publication
(10) Pub. No.: US 2007/0005448 A1
(43) Pub. Date: Jan. 4, 2007

(54) Network support for MLS listing access via mobile terminal

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/158,175

(22) Filed: Jun. 21, 2005

(51) Int. Cl. G06Q 30/00

(52) U.S. Cl. 705/27

(57) ABSTRACT

An apparatus in one example has: a telecommunications network; a mobile terminal and a subscriber database in the telecommunications network; a MLS controller module in the telecommunications network; at least one MLS database operatively coupled to the MLS controller; and the MLS database being accessible by the mobile terminal via the MLS controller.

### TECHNICAL FIELD

The invention relates generally to telecommunication networks, and more particularly to accessing a multiple listing service (MLS).

### BACKGROUND

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate cameras, electronic phonebooks, speed dialing, single button voicemail access, and messaging capabilities, such as e-mail.

Finding real estate, such as a house, a business, vacant property, etc., to purchase can be a very time consuming process. Many times while driving around, people will run across a property of interest to them, but don't know if the property is in their price range, or has enough bedrooms, etc. Such information is contain in what is known as a multiple listing service. Presently, in order to check for the information in the multiple listing service, a person must wait until they can contact a broker at a later time.

The multiple listing service is a marketing organization composed of member brokers who agree to share their listing agreements with one another in the hope of procuring ready, willing and able buyers for their properties more quickly than they could on their own. Most multiple-listing services accept exclusive-right-to-sell or exclusive agency listings from their member brokers.

There are hundreds of multiple listing services across the county. Most local services are run by their local Board of Realtors. The local boards determine the requirements to belong to and to participate in their MLS. It is actually quite common to have overlapping multiple listing services in a particular area. For example, there may be a county MLS in a particular area and also a local service as well.

It is a drawback of the prior art that a person cannot immediately check a MLS when the person first views a particular piece of real estate, such as a home.

### SUMMARY

The invention in one implementation encompasses an apparatus. The apparatus in one embodiment may comprise: a telecommunications network; a mobile terminal and a subscriber database in the telecommunications network; a MLS controller module in the telecommunications network; at least one MLS database operatively coupled to the MLS controller; and the MLS database being accessible by the mobile terminal via the MLS controller.

The invention in a further implementation encompasses a method. The method in one embodiment may comprise: accessing at least one MLS (multiple listing service) database from a mobile terminal in a telecommunications network; and transferring information regarding at least one real estate property from the at least one MLS database to the mobile terminal.

### DESCRIPTION OF THE DRAWINGS

Features of exemplary implementations of the invention will become apparent from the description, the claims, and the accompanying drawings in which:

FIG. 1 is a representation of one implementation of an apparatus that enables a mobile telecommunications network to gain access to the MLS regional and national databases;

FIG. 2 is a representation of one exemplary flow diagram for gaining access to the MLS regional and national databases according to the present method; and

FIG. 3 is a representation of another exemplary flow diagram for gaining access to the MLS regional and national databases according to the present method.

### DETAILED DESCRIPTION

Embodiments of the present method and apparatus enables a mobile subscriber to use a mobile terminal to make a call to a telecommunications network and request listing information on a particular real estate property that is listed as being for sale or rent. The telecommunications network may query the mobile subscriber for the type of listing information being requested—price, square footage, number of bedrooms, city water or well and septic, age of house, number of bathrooms, fireplace, size of lot, school district, etc. The telecommunications network may communicate with a MLS database to access the listing information requested by the mobile subscriber. The telecommunications network may forward that information to the mobile subscriber in their preferred format—an email message, a voice mail message, an SMS message, or a display to the mobile handset device. The telecommunications network may charge the mobile subscriber appropriately for the type and amount of information requested. For example, if only price was requested, that information alone would be delivered for a smaller charge than if price, square footage, and number of bedrooms was requested.

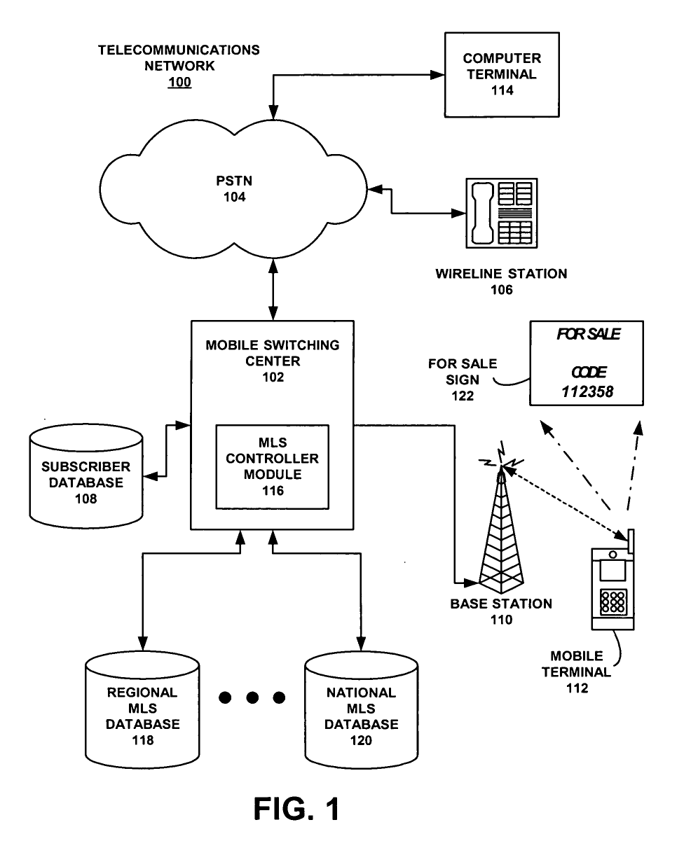

FIG. 1 is a representation of one implementation of an apparatus that enables a mobile telecommunications network to gain access to the MLS regional and national databases.

A telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be connected to the MSC 102. The PSTN 104 may be operatively coupled to a wireline station 106, a computer terminal 114, etc. The PSTN 104 may route calls to and from a mobile terminal 112 through the MSC 102. The MSC 102 may also be connected to at least one base station (BS) 110. The base station 110 communicates with the mobile terminal 112 in its service area using a subscriber database 108. The PSTN 104 generally may be implemented as a worldwide voice telephone network accessible to all those with telephones and access privileges (e.g., AT&T long distance network). The mobile terminal 112 may be any one of a number of devices, such as a cell phone, a personal data assistant (PDA), a laptop computer, etc.

The mobile switching center 102 may have a MLS controller module 116 that in response to request from the mobile terminal 112 retrieves the relevant data for one or more real estate properties from one or more MLS databases, such as regional MLS database 118 and the national MLS database 120. The correct information for a respective real estate property may be obtained by sending a proper code to the telecommunications network. This code may be displayed, for example, on a real estate sign 122 that is located on the real estate property for sale. The code may also be supplied in advertisements, on a real estate web site, etc.

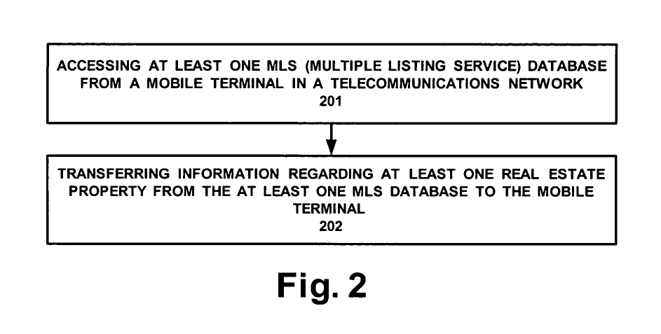

FIG. 2 is a representation of one exemplary flow diagram for gaining access to the MLS regional and national databases according to the present method. This embodiment of the present method may have the steps of: accessing at least one MLS (multiple listing service) database from a mobile terminal in a telecommunications network (201); and transferring information regarding at least one real estate property from the at least one MLS database to the mobile terminal (202).

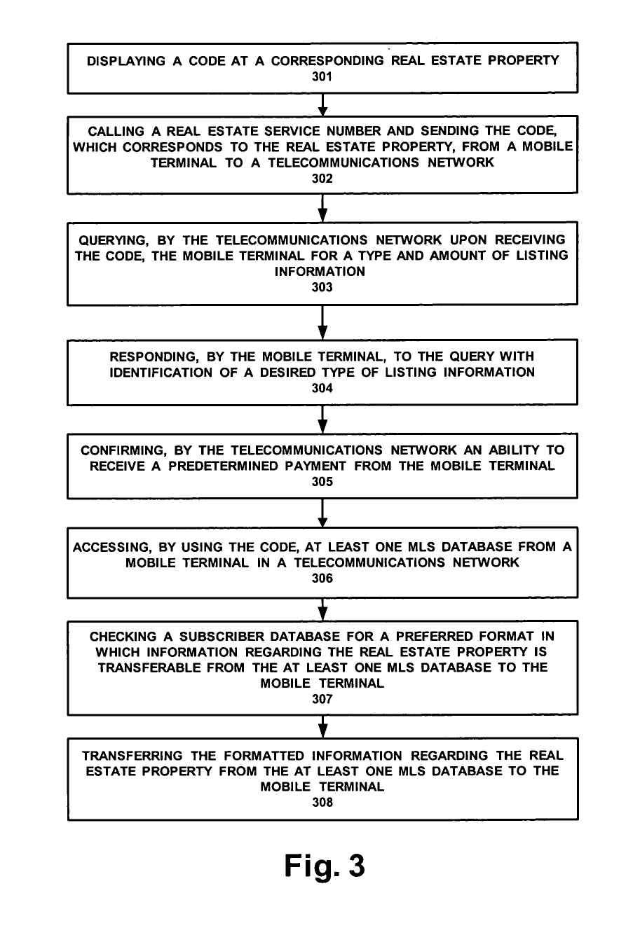

FIG. 3 is a representation of another exemplary flow diagram for gaining access to the MLS regional and national databases according to the present method. This embodiment of the present method may have the steps of: displaying a code at a corresponding real estate property (301); calling a real estate service number and sending the code, which corresponds to the real estate property, from a mobile terminal to a telecommunications network (302); querying, by the telecommunications network upon receiving the code, the mobile terminal for a type and amount of listing information (303); responding, by the mobile terminal, to the query with identification of a desired type of listing information (304); confirming, by the telecommunications network an ability to receive a predetermined payment from the mobile terminal (305); accessing, by using the code, at least one MLS database from a mobile terminal in a telecommunications network (306); checking a subscriber database for a preferred format in which information regarding the real estate property is transferable from the at least one MLS database to the mobile terminal (307); and transferring the formatted information regarding the real estate property from the at least one MLS database to the mobile terminal (308).

The type and amount of listing information may be stored in at least one MLS database. The type and amount of listing information may include at least one of price, square footage, number of bedrooms, city water or well and septic, age of house, number of bathrooms, fireplace, size of lot, and school district. The preferred format may be one of an email message, a voice mail message, an SMS (short message service) message, or a displayable message on the mobile terminal.

A plurality of codes may correspond respectively to a plurality of real estate properties, and the at least one MLS database may store information corresponding to the real estate properties.

Embodiments of the present method and apparatus overcome the drawbacks of the prior art and enables the mobile telecommunications network to gain access to the MLS regional and national databases for the purpose of finding out about a real estate property when driving by a property of interest.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus comprising:
a telecommunications network;
a mobile terminal and a subscriber database in the telecommunications network;
a MLS controller module in the telecommunications network;
at least one MLS database operatively coupled to the MLS controller; and
the MLS database being accessible by the mobile terminal via the MLS controller.

2. The apparatus according to claim 1, wherein the apparatus further comprises at least one code that allows the mobile terminal to access the at least one MLS database.

3. The apparatus according to claim 2, wherein the apparatus further comprises a “for sale” type sign that displays the at least one code.

4. The apparatus according to claim 3, wherein the “for sale” type sign is located on the respective real estate property corresponding to the at least one code.

5. The apparatus according to claim 1, wherein the at least one code corresponds to a respective real estate property; and wherein the at least one MLS database stores predetermined data corresponding to the respective real estate property.

6. The apparatus according to claim 1, wherein the apparatus further comprises a plurality of codes that correspond respectively to a plurality of real estate properties, and wherein the at least one MLS database stores predetermined data corresponding to the real estate properties.

7. A method, comprising:
accessing at least one MLS (multiple listing service) database from a mobile terminal in a telecommunications network; and
transferring information regarding at least one real estate property from the at least one MLS database to the mobile terminal.

8. The method according to claim 7, wherein the method further comprises:
sending a code, which corresponds to the real estate property, from the mobile terminal to the telecommunications network; and
using the code to access the MLS database to retrieve the information regarding the real estate property.

9. The method according to claim 8, wherein, upon receiving the code, the telecommunications network queries the mobile terminal for a type and amount of listing information, and wherein the mobile terminal responds to the query with identification of a desired type of listing information.

10. The method according to claim 9, wherein, upon receiving the code, the telecommunications network queries the mobile terminal for a type and amount of listing information, wherein the mobile terminal responds to the query with identification of a desired type of listing information, and wherein the telecommunications confirms an ability to receive a predetermined payment from the mobile terminal.

11. The method according to claim 9, wherein the type and amount of listing information is stored in at least one MLS database, and wherein the type and amount of listing information comprises at least one of price, square footage, number of bedrooms, city water or well and septic, age of house, number of bathrooms, fireplace, size of lot, and school district.

12. The method according to claim 7, wherein the method further comprises checking the subscriber database for a preferred format in which the information regarding the at least one real estate property is transferred from the at least one MLS database to the mobile terminal.

13. The method according to claim 12, wherein the preferred format is one of an email message, a voice mail message, an SMS (short message service) message, or a displayable message on the mobile terminal.

14. A method, comprising:
sending a code, which corresponds to a real estate property, from the mobile terminal to the telecommunications network;
accessing, by using the code, at least one MLS (multiple listing service) database from a mobile terminal in a telecommunications network;
checking a subscriber database for a preferred format in which information regarding the real estate property is transferable from the at least one MLS database to the mobile terminal; and
transferring the formatted information regarding the real estate property from the at least one MLS database to the mobile terminal.

15. The method according to claim 14, wherein, upon receiving the code, the telecommunications network queries the mobile terminal for a type and amount of listing information, and wherein the mobile terminal responds to the query with identification of a desired type of listing information.

16. The method according to claim 15, wherein, upon receiving the code, the telecommunications network queries the mobile terminal for a type and amount of listing information, wherein the mobile terminal responds to the query with identification of a desired type of listing information, and wherein the telecommunications confirms an ability to receive a predetermined payment from the mobile terminal.

17. The method according to claim 15, wherein the type and amount of listing information is stored in at least one MLS database, and wherein the type and amount of listing information comprises at least one of price, square footage, number of bedrooms, city water or well and septic, age of house, number of bathrooms, fireplace, size of lot, and school district.

18. The method according to claim 14, wherein the preferred format is one of an email message, a voice mail message, an SMS (short message service) message, or a displayable message on the mobile terminal.

19. The method according to claim 14, wherein the method further comprises providing a plurality of codes that correspond respectively to a plurality of real estate properties, and wherein the at least one MLS database stores information corresponding to the real estate properties.

20. The method according to claim 14, wherein the method further comprises displaying the code at the corresponding real estate property.
